(19) United States
(12) Patent Application Publication
(10) Pub. No.: US 2025/0348199 A1
(43) Pub. Date: Nov. 13, 2025

(54) CONTROL METHOD AND DEVICE

(71) Applicant: Lenovo (Beijing) Limited, Beijing (CN)

(72) Inventors: Kai ZONG, Beijing (CN); Ke WANG, Beijing (CN); Yanan CUI, Beijing (CN)

(21) Appl. No.: 19/204,390

(22) Filed: May 9, 2025

(30) Foreign Application Priority Data
May 11, 2024 (CN) 202410584821.8

(51) Int. Cl. G06F 3/04845; G06F 3/04842

(52) U.S. Cl. CPC G06F 3/04845; G06F 3/04842; G06F 2203/04803

(57) ABSTRACT

A control method includes, in response to a target trigger event, activating a target application set matching the target trigger event, and respectively running at least two applications in the target application set in a determined target display area, the target application set including display layout information of the application, and the target display area including at least one display area determined based on the display layout information.

### CROSS-REFERENCES TO RELATED APPLICATION

This application claims priority to Chinese Patent Application No. 202410584821.8 filed on May 11, 2024, the entire content of which is incorporated herein by reference.

### FIELD OF TECHNOLOGY

The present disclosure relates to the field of display technology and, more specifically, to a control method and device.

### BACKGROUND

Often, users need to open multiple software to work, for example, opening a browser to search for information and opening Word or PPT to edit documents at the same time.

In this case, a user often needs to manually open each software in sequence, and the operational complexity is high, which negatively affects user experience.

### SUMMARY

One aspect of this disclosure provides a control method. The control method includes, in response to a target trigger event, activating a target application set matching the target trigger event, and respectively running at least two applications in the target application set in a determined target display area. The target application set includes display layout information of the application, and the target display area includes at least one display area determined based on the display layout information.

Another aspect of this disclosure provides a notebook computer. The notebook computer includes two or more display screens and a processor. The two or more display screens are rotatably connected to each other. The processor is configured to obtain a target trigger event; activate a target application set matching the target trigger event in response to the target trigger event, and to respectively run at least two applications in the target application set in a determined target display area. The target application set includes display layout information of the application, and the target display area includes at least one display area determined based on the display layout information.

Another aspect of this disclosure provides an electronic device. The electronic device includes a display and a processor. The display is used to provide a target display area. The processor is configured to obtain a target trigger event; activate a target application set matching the target trigger event in response to the target trigger event, and to respectively run at least two applications in the target application set in a determined target display area. The target application set includes display layout information of the application, and the target display area includes at least one display area determined based on the display layout information.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a control method according to some embodiments of the present disclosure.

FIGS. 2-5 are examples of target application sets.

FIG. 6 is an example of outputting an application set in a first display area in a notebook computer according to some embodiments of the present disclosure.

FIG. 7 is an example of displaying three display areas in a target display area in a notebook computer according to some embodiments of the present disclosure.

FIG. 8 is an example of a target user selecting an application set in a notebook computer according to some embodiments of the present disclosure.

FIG. 9 is an example of the target user adding an application to the application set in a notebook computer according to some embodiments of the present disclosure.

FIG. 10 is an example of the target user reordering the application set in a notebook computer according to some embodiments of the present disclosure.

FIG. 11 is an example of the target user selecting the application set by inputting data in a notebook computer according to some embodiments of the present disclosure.

FIG. 12 is an example of the target user providing a first prompt in a notebook computer according to some embodiments of the present disclosure.

FIG. 13 is an example of the target user providing a second prompt in a notebook computer according to some embodiments of the present disclosure.

FIG. 14 is an example of the target user customizing the application set in a notebook computer according to some embodiments of the present disclosure.

FIG. 15 is an example of the target user editing the application in a notebook computer according to some embodiments of the present disclosure.

FIG. 16 is an example of determining the application set based on a change in usage mode in a notebook computer according to some embodiments of the present disclosure.

FIG. 17 is an example of determining the application set based on user changes in a notebook computer according to some embodiments of the present disclosure.

FIG. 18 is an example of determining the application set based on usage state change information and external reference factors in a notebook computer according to some embodiments of the present disclosure.

FIG. 19 is an example of determining the application set when the notebook computer switches from the usage mode of being connected to the Internet to being disconnected from the Internet according to some embodiments of the present disclosure.

FIG. 20 is an example of determining the application set when the notebook computer switches from a single-use mode to a mode in which the electronic device is connected to other devices for use according to some embodiments of the present disclosure.

FIG. 21 is an example of determining the application set when the notebook computer enters a book mode and is disconnected from the Internet according to some embodiments of the present disclosure.

FIG. 22 is an example of determining the application set when the notebook computer is interconnected with a display screen and is connected to the Internet according to some embodiments of the present disclosure.

FIG. 23 is an example of determining the application set when the notebook computer login user is user 2 according to some embodiments of the present disclosure.

FIG. 24 is an example of determining the application set when the notebook computer enters a laptop mode and is connected to the Internet according to some embodiments of the present disclosure.

FIG. 25 is a schematic diagram of an application layout for a single-screen device according to some embodiments of the present disclosure.

FIG. 26 is a schematic diagram of the layout of two applications for a dual-screen notebook computer according to some embodiments of the present disclosure.

FIG. 27 is a schematic diagram of the layout of three two applications for the dual-screen notebook computer according to some embodiments of the present disclosure.

FIG. 28 is an example of adjusting the application set when an interconnected display screen of the notebook computer is disconnected according to some embodiments of the present disclosure.

FIG. 29 is an example of adjusting the application set when an application is adjusted according to some embodiments of the present disclosure.

FIG. 30 is a schematic structural diagram of a control device according to some embodiments of the present disclosure.

FIG. 31 is a schematic structural diagram of an electronic device according to some embodiments of the present disclosure.

FIG. 32 is an example of some possible application combinations on the dual-screen notebook computer in a landscape mode according to some embodiments of the present disclosure.

FIG. 33 is an example of some possible application combinations on the dual-screen notebook computer in a portrait mode with screen B on the left according to some embodiments of the present disclosure.

FIG. 34 is an example of some possible application combinations on the dual-screen notebook computer in the portrait mode with screen B on the right according to some embodiments of the present disclosure.

FIG. 35 is a flowchart of identifying a combination of applications used frequently in a notebook computer according to some embodiments of the present disclosure.

FIG. 36 is a flowchart of recommending and launching application combinations in a notebook computer according to some embodiments of the present disclosure.

FIG. 37 is an example of a quick launch window for application combinations in a notebook computer according to some embodiments of the present disclosure.

FIG. 38 is a schematic diagram of a window applicable to manual setting and adjustment of application combinations by users in a notebook computer according to some embodiments of the present disclosure.

### DETAILED DESCRIPTION

Technical solutions of the present disclosure will be described in detail with reference to the drawings. It will be appreciated that the embodiments described represent some, rather than all, of the embodiments of the present disclosure. Other embodiments conceived or derived by those having ordinary skills in the art based on the described embodiments without inventive efforts should fall within the scope of the present disclosure.

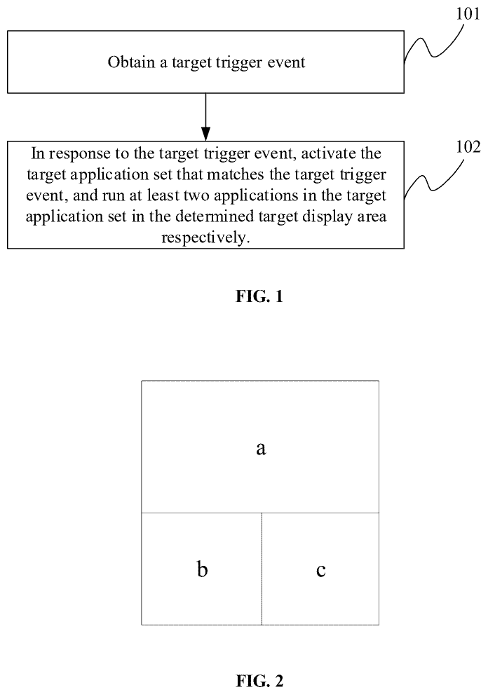

FIG. 1 is a flowchart of a control method according to some embodiments of the present disclosure. The method can be applied to electronic devices with application programs installed, such as mobile phones, notebook computers, tablet devices or desktop computers. The technical solutions provided in the embodiments of the present disclosure can be used to improve the user experience of using an electronic device. The method will be described in detail below.
101, obtaining a target trigger event.

In some embodiments, the target trigger event may be an event generated on the electronic device to indicate the start of multiple applications. For example, the target trigger event may be the event of powering on the electronic device, the event of switching the usage mode, the event of changing the usage environment, the event of changing the user, the event of changing the usage time, the event of changing the network connection, the event of changing the usage mode of the electronic device, the event of updating the application installed on the electronic device, etc. The event of switching the usage mode may include switching from a laptop mode to an e-book mode, switching of the electronic device, etc. The event of changing the usage environment may include the event of changing the usage location (position), the event of changing the brightness of the usage environment, etc.
102, in response to the target trigger event, activating a target application set matching the target trigger event, at least two applications in the target application set being respectively run in a determined target display area.

In some embodiments, the target application set matching the target trigger event may include filtering out the application set that matches the target trigger event from a set list including multiple application sets. The target application set may include at least two applications, and the applications in the target application set may be already started or not yet started. In the process at 102, activating the target application set may include starting the applications in the target application set that are still in an inactive state, and keeping the applications in the target application set that are already in the inactive state in an active state. That is, for applications in the target application set that are already in the active state, these applications that are already in the active state can be directly used in the process at 102. For the applications in the target application set that are in the inactive state, in the process at 102, these applications that are in the inactive state can be first activated, and then the applications that enter the active state can be used.

In some embodiments, the target display area may be an area where application windows or task windows of applications in the target application set are output. The target display area may include one or more display areas, which can be used to output application windows or task windows of applications in the target application set. In some embodiments, the target display area may be determined through interactive operations, historical data, application information, target user habits, and the like.

It should be noted that the target application set may also include display layout information of the application. The display layout information is used to indicate the layout state of the display area where the application window of each application in the target application set is located. In some embodiments, the display layout information may include information such as the display position information of the application window, the display mode (such as full screen display or window display), and the arrangement of the application window.

For example, the target application set includes three applications a, b, and c, as well as the display layout information of these three applications. As shown in FIG. 2, based on the display layout information, the display areas corresponding to the three applications can be determined such that the three applications can respectively run in the corresponding display areas. Accordingly, the application windows of the three applications can be respectively output in the corresponding display areas.

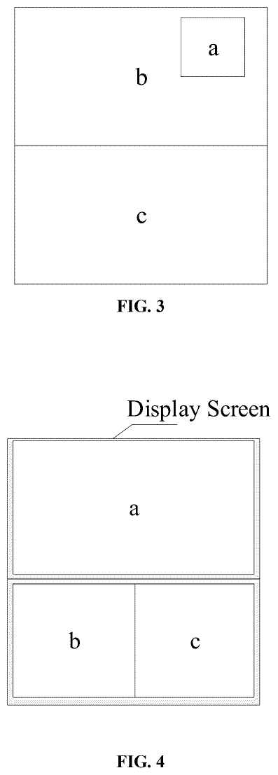

It should be noted that the target display area may be determined based on the display layout information, or may also be determined based on application attributes or target user adjustment operations on the application. For example, the target display area may be determined based on the display layout information in the target application set in conjunction with the application attributes of each application in the target application set and the adjustment operation of the target user on any application in the target application set such that each application in the target application set can be run in the corresponding display area. Refer to FIG. 3, application a may be a calculator application. In this case, three display areas are determined in conjunction with the display layout shown in FIG. 2 and the attributes of application a. The display area corresponding to application a covers part of the display area of application b, and the display area of application c and the display area of application b respectively cover their corresponding display areas.

Consistent with the present disclosure, in response to a target trigger event, a target application set matching the target trigger event can be activated, and at least two applications in the target application set can be respectively run in the determined target display area. The target application set also includes the display layout information of the application, and at least one display area in the target display area where the application runs can be determined based on the display layout information in the target application set. Accordingly, based on the display layout information, the applications in the application set can be run in the corresponding display areas. There is no need for the user to manually activate each application or manually adjust the display area where each application runs, thereby reducing the user's operation complexity and improving the user experience.

In some embodiments, the process at 102 may be implemented as follows.

First, in response to a target trigger event, at least one application set matching the target trigger event can be output in a first display area of the electronic device. The application sets may include display layout information of the included applications. Based on this, at least one application set outputted by the first display area can be provided to the target user for target operation. The target operation can act on the first display area, more specifically, on an application set in the first display area. For example, the target user may click on one of the application sets in the first display area.

Then, in response to the target operation acting on the first display area, at least two applications in the target application set determined by the target operation can be respectively run in at least two display areas. The at least two display areas may be determined based on display layout information included in the target application set, and the at least two display areas may belong to the same display module or different display modules.

In some embodiments, in addition to the events described above, the target trigger event may also be an event that calls the application set for the target user. For example, the event of the target user calling an application set may include: an event in which the target user clicks on a call-out control corresponding to an application set, an event in which the target user calls out an application set from a taskbar or a hidden tray, and an event in which the target user calls out an application set using a shortcut key.

In some embodiments, the first display area may be an area in the electronic device that can output the application set, such as a pop-up window or a user interface (UI) that can output the application set.

It should be noted that the at least one application set matching the target trigger event may include: a preset application set unrelated to the target user, an application set determined based on the target user's application usage information such as habits or preferences, and an application set configured by the target user.

In some embodiments, the application usage information may be obtained based on the historical application usage information of the target user.

The target operation may include: a target user's selection operation on the application set in the first display area, a custom addition operation on the application set, an editing operation on at least one application in the application set, a sorting operation on the application set, an input operation representing the target intention, etc.

In some embodiments, the selection operation may be used to point to one of the application sets in the first display area; the custom addition operation may be used to add a new application set in the first display area; the editing operation may be used to delete, replace or add a new application to one or more applications in any one or more application sets in the first display area; the sorting operation may be used to re-sort the application set in the first display area; the input operation representing the target intention may be used to input data on the electronic device to represent the target intention, and the target intention may be used for one of the application sets in the first display area.

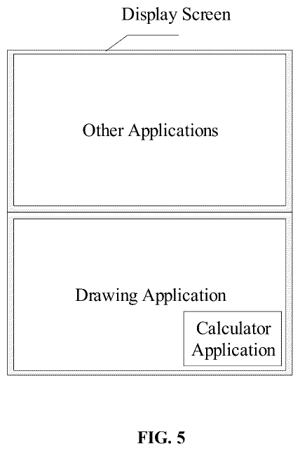

It should be noted that each application in the target application set may run in a display area. That is, the number of display areas in the target display area may be consistent with the number of applications in the target application set. The display areas where each application is located may not overlap. For example, as shown in FIG. 4, the display areas where applications a, b, and c are located may be adjacent to each other and display the entire display screen of the module. Or, there may be an overlap between the display areas where at least two applications are located. For example, as shown in FIG. 5, the display area where the calculator application is located is suspended in the lower right corner area of the display area where the drawing application is located, as shown in FIG. 5. At this time, the display area where the calculator application is located overlaps with the lower right corner area of the display area where the drawing application is located. Although the calculator application blocks part of the content of the drawing application, it does not affect the use of the drawing application.

For example, as shown in FIG. 6, the target user moves the mouse to the hidden tray on the right side of the laptop screen on side B, generating a target trigger event on the notebook computer. In response to the target trigger event, three application sets (also referred to as app sets) are output in the lower right corner area (i.e., the first display area) of the screen on the side B of the notebook computer. Each application set includes multiple application IDs. The application IDs in each application set are output in the lower right corner based on the display layout information. The target user can manually click on one of the application sets as needed to generate a corresponding target operation on the notebook computer. The target operation acts on the target application set in the lower right corner area. In response to the target operation, applications a, b and c in the determined target application set are respectively run in each display area determined by the display layout information.

It should be noted that at least two display areas in the target display area may belong to the same display module or different display modules. At least two display areas in the target display area may belong to the same display module, which can be understood as the electronic device being a device with a single display module, such as a notebook computer with only side B being a display screen. Different display modules may be different display modules on the same electronic device, such as a notebook computer whose B side and C side are both display screens, including two display modules on the B side and the C side. Or, different display modules may be different display modules on different electronic devices, for example, an external display screen of a notebook computer and the B side and C side of the notebook computer are different display modules.

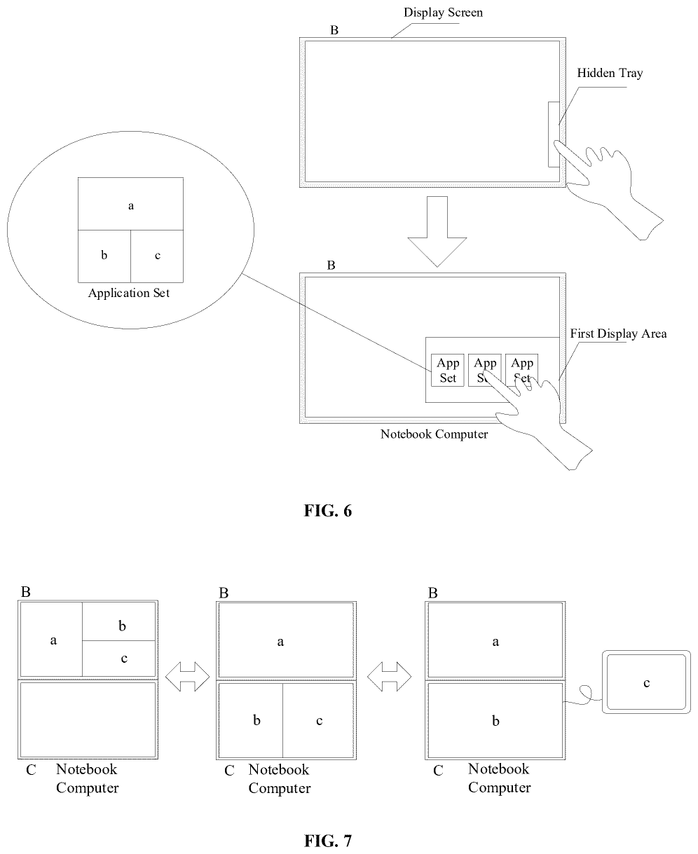

Take a target display area with three display areas as an example. As shown in FIG. 7, the three display areas can all be on side B of the notebook computer; or, in the three display areas, the display area of application a is on side B of the notebook computer, and the display areas of application b and application c are on side C of the notebook computer; or, in the three display areas, the display area of application a is on side B of the notebook computer, the display area of application b is on side C of the notebook computer, and the display area of application c is on the external display screen of the notebook computer.

Based on the examples, in the process at 102, that is, when at least two applications in the target application set determined by the target operation are respectively run in at least two display areas in response to the target operation acting on the first display area, the process may be implemented in at least one of the following manners.

In some embodiments, in response to a selection operation acting on the first display area, the selection operation may point to an application set in the first display area, namely, the first application set. Based on this, at least two applications in the first application set pointed by the selection operation can be respectively run in at least two display areas determined based on the display layout information in the first application set.

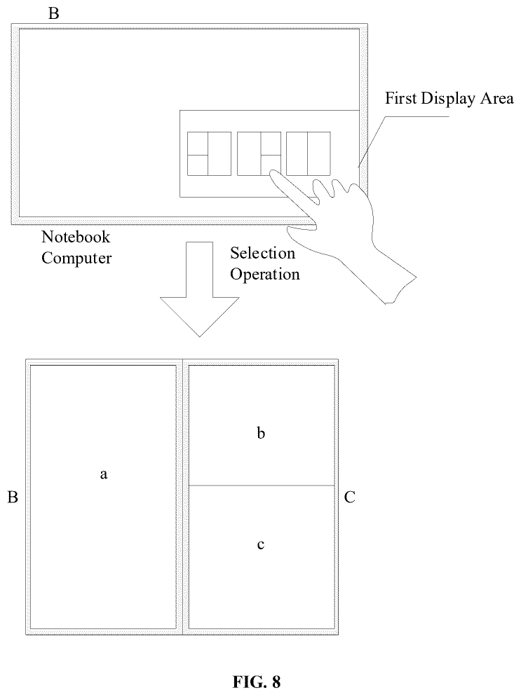

For example, as shown in FIG. 8, three application sets are output in the lower right corner area (i.e., the first display area) of the screen on side B of the notebook computer. The identifiers of the applications in each application set can be output in the lower right corner area based on the display layout information. The target user can select one of the application sets in the lower right corner based on the needs. The application set including applications a, b, and c pointed to by the selection operation is noted as the first application set. In response to the selection operation, applications a, b, and c in the first application set pointed to by the selection operation can be respectively run in each display area determined by the display layout information. That is, application a runs in the display area on the left, application b runs in the display area on the upper right side, and application c runs in the display area on the lower right side.

In some embodiments, in response to a custom configuration operation acting on the first display area, at least two applications in the second application set custom configured by the target user can be respectively run in at least two display areas determined based on the display layout information in the second application set.

The custom configuration operation may include: adding a new application set to the first display area, adding one or more new applications to one or more application sets in the first display area, deleting one or more applications from one or more application sets in the first display area, replacing one or more applications from one or more application sets in the first display area, adjusting the display layout information of one or more application sets in the first display area, etc. Based on this, the application set corresponding to the custom configuration operation, that is, the new application set obtained by the target user's custom configuration, can be noted as a second application set.

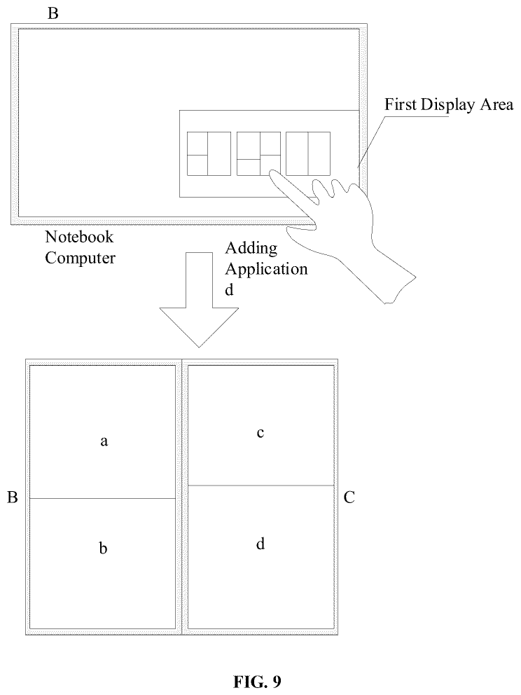

For example, as shown in FIG. 9, three application sets are output in the lower right corner area (i.e., the first display area) of the screen on side B of the notebook computer. The identifiers of the applications in each application set can be output in the lower right corner area based on the display layout information. The target user can perform a custom configuration operation on one of the application sets including applications a, b, and c in the lower right corner area based on needs, such as adding a new application d. The resulting application set including applications a, b, c, and d is noted as the second application set. In response to the custom configuration operation, applications a, b, c, and d in the application set corresponding to the custom configuration operation can be respectively run in each display area determined by the display layout information. That is, application a runs in the upper left half of the display area, application b runs in the lower left half of the display area, application c runs in the upper right half of the display area, and application d runs in the lower right half of the display area.

In some embodiments, in response to a sorting operation acting on the first display area, at least two applications in the third application set in the target sequence can be respectively run in at least two display areas determined based on the display layout information in the third application set.

The sorting operation may be an operation to re-sort the application set in the first display area. The application set in the target sequence after re-sorting in the application set outputted in the first display area can be noted as a third application set. The target sequence may be a first sequence or other specific sequence. That is, in this embodiment, the application set in the first sequence or the specific sequence in the noted application set in the first display area can be noted as the third application set.

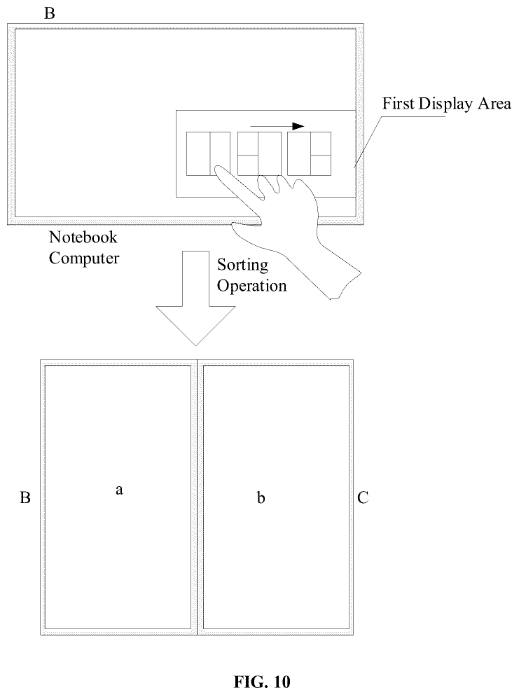

For example, as shown in FIG. 10, three application sets are output in the lower right corner area (i.e., the first display area) of the screen on side B of the notebook computer. The target user can move the last application set including applications a and b in the lower right corner area to the first one as needed, and move the original first application set and the original second application set backwards. The application set including applications a and b can be noted as the third application set. In response to the sorting operation, applications a and b in the first application set after the sorting operation can be respectively run in each display area determined by the display layout information. That is, application a runs in the display area on the left, and application b runs in the display area on the right.

In some embodiments, in response to obtaining the first input data representing the target intent, at least two applications in a fourth application set matching the target intent can be respectively run in at least two display areas determined based on the display layout information in the fourth application set.

In some embodiments, the first input data may be input data obtained through a camera, microphone, text input box, etc. of the electronic device. Based on the first input data, a corresponding input instruction such as a gesture instruction, a voice instruction or a string instruction can be generated, and then the target intention can be determined based on the input instruction. The target intent points to one of the application sets in the first display area. The application set pointed to by the target intent can be noted as a fourth application set. The fourth application set is an application set that meets the user intent.

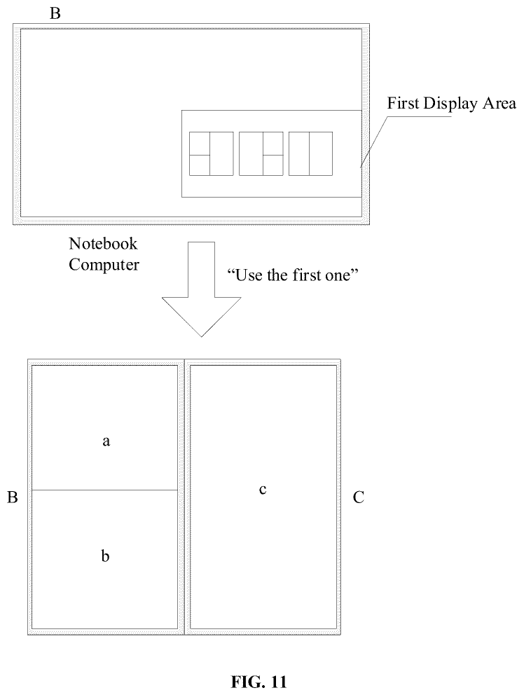

For example, as shown in FIG. 11, three application sets are output in the lower right corner area (i.e., the first display area) of the screen on side B of the notebook computer. The target user can say “use the first one” to the microphone, and the notebook computer generates a voice command based on the voice input data to determine the target intent corresponding to the second application set. This second application set can be noted as the fourth application set. Based on this, in response to the above voice input data, the applications a, b, and c of the fourth application set corresponding to the target intent represented by the voice input data can be respectively run in each display area determined by the display layout information. That is, application a runs in the upper left half of the display area, application b runs in the lower left half of the display area, and application c runs in the right half of the display area.

In some embodiments, the process at 102 may also be implemented as: in response to the target trigger event, outputting a first prompt of a fifth application set matching the target trigger event in a second display area of the electronic device. The first prompt may be used to prompt the target user whether to activate the application in the fifth application set. That is, the first prompt is used to prompt the target user whether to accept the application in the fifth application set currently recommended. The target user may perform a feedback operation on the first prompt, and in response to the feedback operation, the first feedback information or other feedback information may be generated. The first feedback information may indicate that the target user determines to activate the application in the fifth application set, and the other feedback information may indicate that the target user determines not to activate the application in the fifth application set. The process may also include, in response to obtaining the first feedback information for the first prompt, respectively running at least two applications in the fifth application set in at least two display areas determined based on the display layout information in the fifth application set. These display areas may belong to the same display module or different display modules.

Therefore, in this embodiment, the target application set matching the target trigger event is not directly activated, instead, the first prompt is output to the target user first, and whether to activate the corresponding application is determined based on whether the target user accepts the recommended target application set. This avoids the situation where the activated applications do not meet the needs of the target users, which improves the user experience.

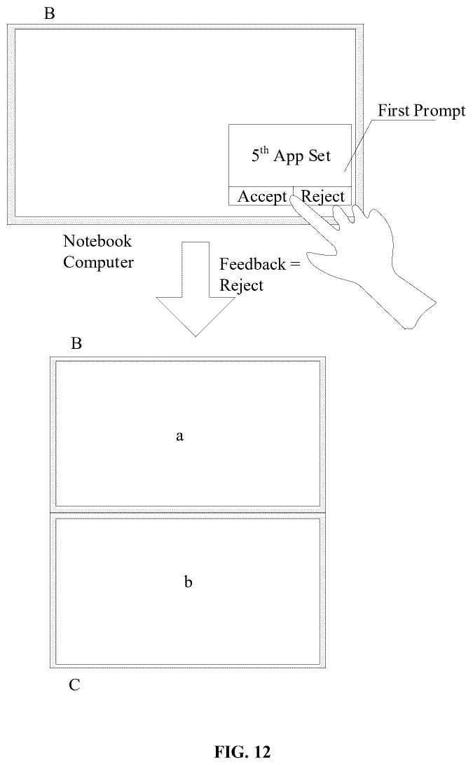

For example, as shown in FIG. 12, in response to the power-on event, the notebook computer outputs a first prompt in the lower right corner on side B of the notebook computer, the first prompt being used to prompt whether to activate the fifth application set matching the power-on event. The fifth application set includes application a and application b, and the display layout information indicates that application a and application b respectively run two display areas of left and right layouts. Based on this, the target user provides feedback based on the first prompt, that is, the feedback can activate application a and application b. In response to the feedback (i.e., the first feedback information), application a is run in the display area on side B of the notebook computer, and application b is run in the display area on side C of the notebook computer. Sides B and C of the notebook computer may belong to different display modules on the notebook.

Based on the above example, the process at 102 may also be implemented as: in response to obtaining the second feedback information for the first prompt, outputting a second prompt of a sixth application set matching the target trigger event in a second display area or a third display area of the electronic device, at least one application and/or display layout information in the sixth application set being different from those in the fifth application set.

In some embodiments, the second feedback information may indicate that the target user determines not to activate the application in the fifth application set. That is, the applications in the fifth application set do not meet the application usage requirements of the target users. Based on this, a second prompt can be output in the second display area where the first prompt is located or in another third display area, and the second prompt can be used to prompt the target user whether to activate an application in the sixth application set. The target user may provide feedback on the second prompt, and in response to the feedback, the third feedback information or other feedback information may be generated. The third feedback information may indicate that the target user determines not to activate the applications in the sixth application set, and the other feedback information may indicate that the target user determines to activate the applications in the sixth application set. Further, in this embodiment, in response to the feedback information indicating that the target user determines to activate an application in the sixth application set, at least two applications in the sixth application set can be respectively run in at least two display areas determined based on the display layout information in the sixth application set.

The sixth application set being different from the fifth application set may be understood as: at least one application in the sixth application set is different from the applications in the fifth application set, and/or the display layout information in the sixth application set is different from the display layout information in the fifth application set. For example, the sixth application set includes applications a, b, and e, but the fifth application set includes applications a, b, and c. In another example, the sixth application set includes applications a, b, and c, and the fifth application set also includes applications a, b, and c, but the layout of the display area where applications a, b, and c are located in the sixth application set is different from the layout of the display area where applications a, b, and c are located in the fifth application set.

It should be noted that the sixth application set may be re-screened from a set list based on the target trigger event; or, the sixth application set may be obtained by correcting the applications and/or display layout information in the fifth application set.

Therefore, in this embodiment, after the first prompt is output to the target user, if the target user is not satisfied with the fifth application set, a second prompt may be output to the target user, thereby making a second application set recommendation. Accordingly, whether to activate the corresponding application is determined based on whether the target user accepts the recommended target application set, thereby avoiding the situation where the activated application does not meet the needs of the target user and improving the user experience.

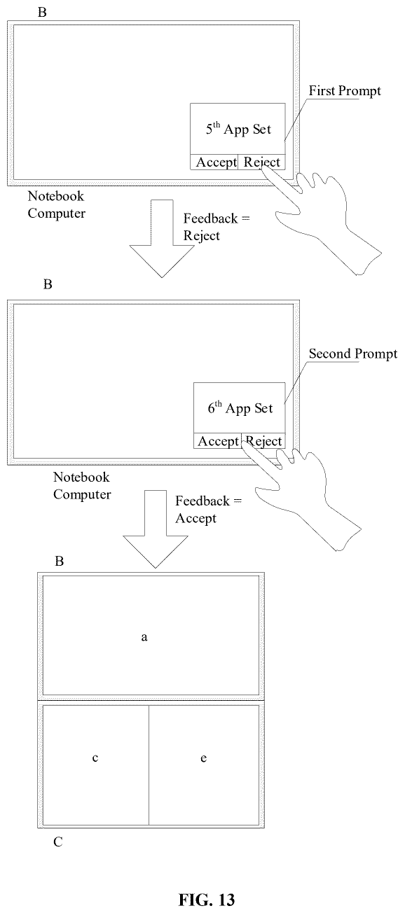

For example, as shown in FIG. 13, in response to the power-on event, the notebook computer outputs a first prompt in the lower right corner on side B of the notebook computer, the first prompt being used to prompt whether to activate the fifth application set matching the power-on event. The fifth application set includes application a and application b. Based on this, the target user provides feedback based on the first prompt, such as providing feedback that he does not accept the activation of application a and application b. In response to the feedback (i.e., the second feedback information), the notebook computer outputs a second prompt in the lower right corner area (or, the second prompt information can also be output in other areas different from the lower right corner area, that is, the first and second prompts may be in different positions for the recommended application sets.). The second prompt is used to prompt whether to activate the sixth application set matching the power-on event, and the sixth application set includes applications a, c, and e. Based on this, the target user provides feedback based on the second prompt, that is, feedback to activate applications a, c, and e. In response to the feedback, application a is run in the display area on side B of the notebook computer, application c is run in the display area on the left side of side C of the notebook computer, and application e is run in the display area on the right side of side C of the notebook computer.

Based on the above example, the process at 102 may also be implemented as: in response to obtaining third feedback information for the first prompt or the second prompt, outputting a third prompt for custom configuring the target application set in the first display area of the electronic device to prompt the target user to configure the needed target application set.

In some embodiments, the third feedback information for the first prompt may be the second feedback information for the first prompt, both of which indicate that the target user does not accept the application in the fifth application set recommended for the first time. The third feedback information for the second prompt may indicate that the target user does not accept the application in the sixth application set recommended for the second time. Based on this, in this embodiment, when the application set recommended for the first time or the recommended twice does not meet the target user's application usage requirements, a third prompt can be output to prompt the target user to customize the needed target application set.

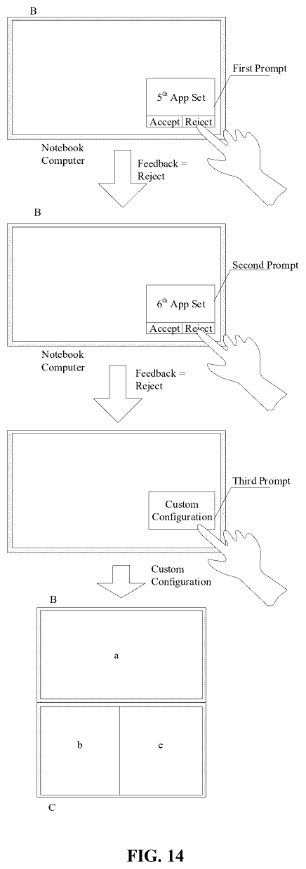

For example, as shown in FIG. 14, in response to the power-on event, the notebook computer outputs a first prompt in the lower right corner on side B of the notebook computer, the first prompt being used to prompt whether to activate the fifth application set matching the power-on event. The fifth application set includes application a and application b. Based on this, the target user provides feedback based on the first prompt, such as feedback that he does not accept the activation of application a and application b. In response to the feedback (i.e., the second feedback information), the notebook computer outputs a second prompt in the lower right corner area (or, the second prompt information may also be output in an area other than the lower right corner area, that is, the first and second prompts may be in different positions for the recommended application sets.). The second prompt is used to prompt whether to activate a sixth application set matching the power-on event, where the sixth application set includes applications a, c, and e. Based on this, the target user provides feedback based on the second prompt, that is, feedback that he does not accept applications a, c, and e. In response to the feedback, the notebook computer outputs a third prompt in the lower right corner area on side B to prompt the target user to customize a target application set. For example, the target user can click the “+” area in the lower right corner, and the target user can configure the corresponding applications a, b, and e on the corresponding custom interface, thereby obtaining the target application set. Based on this, application a is run in the display area of side B of the notebook computer, application b is run in the display area on the left side of side C of the notebook computer, and application e is run in the display area on the right side of side C of the notebook computer.

Based on the above example, the process at 102 may also be implemented as: in response to obtaining fourth feedback information for the first prompt or the second prompt, outputting a fourth prompt for an editing operation for the fifth application set or the sixth application set to prompt the target user to perform an editing operation on the fifth application set or the sixth application set.

In some embodiments, the fourth feedback information for the first prompt information may be the second feedback information for the first prompt, both indicating that the target user does not accept the application in the fifth application set recommended for the first time. Based on this, in the embodiments of the present disclosure, when the fifth application set recommended for the first time does not meet the target user's application usage requirements, a fourth prompt may be output to prompt the target user to edit the applications and/or display layout information in the fifth application set recommended for the first time to obtain a target application set that meets the target user's requirements. Then, at least two applications in the target application set compiled from the fifth application set can be respectively run in at least two display areas determined based on the display layout information in the target application set.

In some embodiments, the fourth feedback information for the second prompt may be the third feedback information for the second prompt, both indicating that the target user does not accept the application in the sixth application set recommended for the second time. Based on this, in the embodiments of the present disclosure, when two consecutively recommended application sets do not meet the target user's application usage requirements, a fourth prompt may be output to prompt the target user to edit the applications and/or display layout information in the fifth application set recommended for the first time or the sixth application set recommended for the second time, such as adding applications, deleting applications, replacing applications, adjusting display layout information, etc. in the application set to obtain the target application set that meets the needs of the target users. Then, at least two applications in the target application set compiled from the fifth application set can be respectively run in at least two display areas determined based on the display layout information in the target application set.

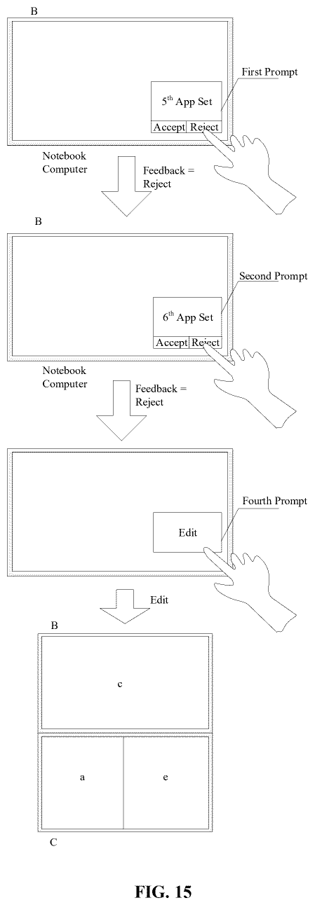

For example, as shown in FIG. 15, in response to the power-on event, the notebook computer outputs a first prompt in the lower right corner on side B of the notebook computer, the first prompt being used to prompt whether to activate the fifth application set matching the power-on event. The fifth application set includes application a and application b. Based on this, the target user provides feedback based on the first prompt, such as feedback that he does not accept the activation of application a and application b. In response to the feedback (i.e., the second feedback information), the notebook computer outputs a second prompt in the lower right corner area (or, the second prompt information may also be output in an area other than the lower right corner area, that is, the first and second prompts may be in different positions for the recommended application sets.). The second prompt is used to prompt whether to activate a sixth application set matching the power-on event, where the sixth application set includes applications a, c, and e. Based on this, the target user provides feedback based on the second prompt, that is, feedback that he does not accept applications a, c, and e. In response to the feedback, the notebook computer outputs a fourth prompt in the lower right corner area of side B to prompt the target user to adjust the applications and/or display layout information in the fifth application set including applications a and b or the sixth application set including applications a, c, and e to obtain a target application set that meets the requirements. For example, the target user can drag the logo of application a in the sixth application set to the position of the logo of application c such that application a and application c exchange layout positions, thereby obtaining the target application set. Based on this, application c is run in the display area on side B of the notebook computer, application a is run in the display area on the left side of side C of the notebook computer, and application e is run in the display area on the right side of the side C of the notebook computer.

In some embodiments, in the process at 102, when the target application set matching the target trigger event is activates in response to the target trigger event, the process may include, if the target trigger event is unrelated to the usage state of the electronic device, activating the target application set matching the target trigger event based on a preset association relationship between the target trigger event and the target application set, and respectively running at least two applications in the target application set in at least two display areas.

In some embodiments, the target trigger events that are unrelated to the usage state of the electronic device may include an event caused by changes in the usage environment, an event caused by changes in the usage time, etc.

It should be noted that different target trigger events may have preset association relationships with the same or different target application sets. That is, the target trigger event mapping has a corresponding target application set. If the target trigger event is unrelated to the usage state of the electronic device, then based on the preset association relationship, a target application set matching the target trigger event can be determined. Then, the target application set can be activated, and at least two applications in the target application set can be respectively run in at least two display areas determined based on the display layout information in the target application set.

For example, the target trigger event is an event in which the usage environment changes, such as a laptop being carried from the office to home by the user. In response to the target trigger event, a target application set is filtered from an application set associated with an event in which the usage environment has changed, such as an application set including a video application and a social application.

In another example, the target trigger event is an event in which the usage time changes, such as switching the notebook computer from holidays to weekdays. In response to the target trigger event, a target application set is filtered out from the application sets associated with the event in which the usage time changes, such as an application set including a document editing application, a calculator application, and a conference application.

In some embodiments, in the process at 102, when the target application set matching the target trigger event is activated in response to the target trigger event, the process may include, if the target trigger event is related to the usage state of the electronic device, activating the corresponding target application set based on the usage state change information. For example, a target application set corresponding to the usage state change information is output in the first display area, and in response to a target operation acting on the first display area, at least two applications in the target application set determined by the target operation are respectively run in at least two display areas.

In some embodiments, the target trigger events related to the usage state of the electronic device may include an event of powering on the electronic device, an event of switching usage modes, an event of changes in the usage form of the electronic device, an event of changes in the user, an event of changes in the network connection, an event of updates to applications installed on the electronic device, etc.

It should be noted that the usage state change information may include the usage state information after the change, and may also include the usage state information before and after the change. The target application set corresponding to the usage state change information may be obtained by, in the set list, filtering the target application set based on the changed usage state information.

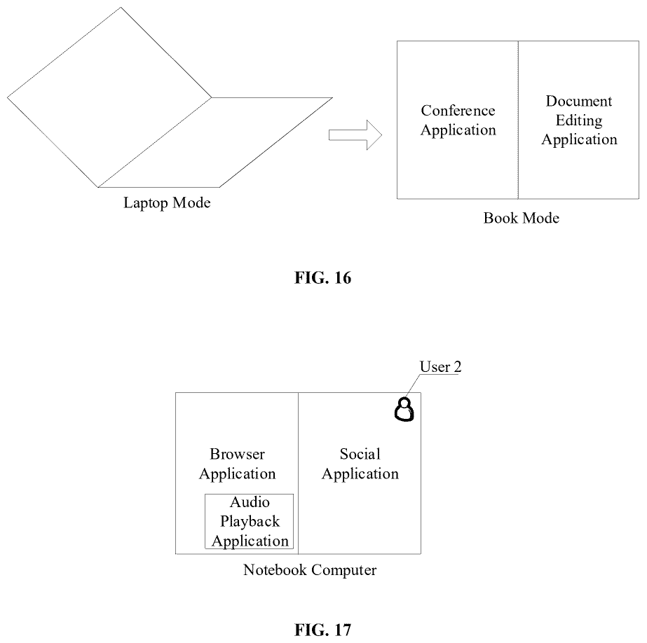

Take a notebook computer as an example. The notebook computer switches from the laptop mode to a book mode, as shown in FIG. 16. In this case, based on the switched book mode, an application set with the highest usage frequency in the book mode is selected from the set list as the target application set, such as a conference application and a document editing application. Based on this, the conference application and the document editing application are activated, and the conference application is run on side B of the notebook computer, and the document editing application is run on side C of the notebook computer.

Take a notebook computer as an example again. The logged-in user of the notebook computer is switched from user 1 to user 2, as shown in FIG. 17. In this case, based on the switched user 2, an application set with the highest usage frequency by user 2 is selected from the set list as the target application set, such as an audio playback application, a browser application, and a social application. The browser application is run in the display area on side B of the notebook computer, the audio playback application is run on side B of the notebook computer and cover the lower left corner area of the browser application, and the social application is run on the display area on side C of the notebook computer.

In some embodiments, in the process at 102, when the target application set matching the target trigger event is activated in response to the target trigger event, the process may include, if the target trigger event is related to the usage state of the electronic device, activating the corresponding target application set based on the usage state change information and external reference factors, and respectively running at least two applications in the target application set in at least two display areas.

In some embodiments, external reference factors refer to factors that are unrelated to the use status of the electronic device, such as the use environment factors, the use time factors, etc. For example, each application set in the set list may have a usage state attribute and a usage environment attribute. The usage state attribute may be an attribute related to the usage state. For example, the usage state attribute may include: whether the electronic device is turned on, the current usage mode, the current usage form, the currently logged-in user, whether the electronic device is connected to the network, the updated application, etc. The usage environment attribute may be an attribute that is not related to the usage state. For example, the usage environment attribute may include the current usage location, the current usage time, etc. In some embodiments, the target application set may be be determined by, in the set list, first, based on the current usage location and current usage time of the electronic device, selecting one or more corresponding application sets. The usage environment attributes of the filtered application set are consistent with the current usage location and current usage time of the electronic device. Subsequently, from the filtered application sets, a target application set can be filtered out based on the usage status change information, that is, the changed usage state attribute.

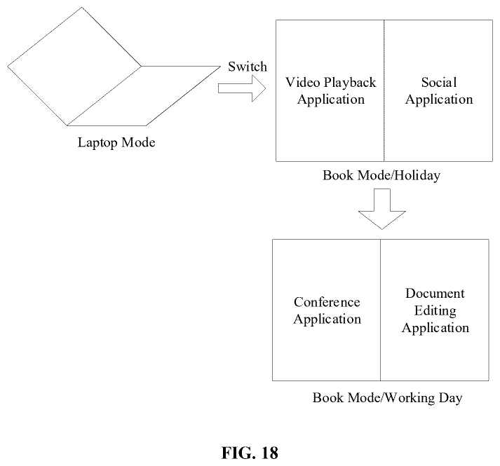

Take a notebook computer as an example. The notebook computer switches from the laptop mode to a book mode, as shown in FIG. 18. If today is a holiday, then in this embodiment, based on the book mode switched to, the application set with the highest usage frequency in the book mode and the usage environment attribute of holidays can be selected from the set list as the target application set, such as the video playback application and the social application. If today is a working day, then in this embodiment, based on the book mode switched to, the application set with the highest usage frequency in the book mode with the usage environment attribute of working days can be filtered out from the set list as the target application set, such as the conference application and the document editing application.

In some embodiments, in the process at 102, when the target application set matching the target trigger event is activated in response to the target trigger event, the process may include, in response to the electronic device switching from a first power state to a second power state, outputting a preset application set in the first display area, the preset application set including one or more preset application sets, the preset application set being created based on big data or user profile data of the target user and/or configuration information of the electronic device. Then, in response to the target operation on the first display area, respectively running at least two applications in the preset application set directed by the target operation in at least two display areas determined based on the display layout information in the preset application set.

In some embodiments, the electronic device switching from the first power state to the second power state may be switching from the electronic device being powered off to being powered on, i.e., a power-on event. The power-on event here can be the first power-on event of the electronic device after leaving the factory, or it can also be a non-first power-on event.

In some embodiments, the preset application set may be determined based on big data. For example, if the electronic device switches from the first power state to the second power state for the first time, i.e., it is turned on for the first time, then big data can be collected from the Internet and one or more application sets that are commonly used and used the most by users can be learned based on the big data, and these application sets can be determined as the preset application sets.

Alternatively, the preset application set may be determined based on the user profile data of the target user. The target user may be the user logging into the electronic device. The user profile data of the target user may be obtained by collecting the target user's historical usage traces of electronic devices. For example, if the electronic device is not turned on for the first time, in this case, the historical application sets started by the target user based on the preferences or habits when using the electronic device can be collected, and then these historical application sets can be determined as the preset application sets.

Alternatively, the preset application set may be determined based on the configuration information of the electronic device. The configuration information of the electronic device may include the number of display modules configured in the electronic device, the display screen size of each display module, performance parameters and other information, etc. For example, if the electronic device is turned on, then in this case, the size of the display area that the electronic device can achieve can be determined based on the configuration information of the electronic device, and then the display layout information can be generated for the application in the determined preset application set.

Alternatively, the preset application set may be determined based on the user profile data of the target user and the configuration information of the electronic device. For example, if the electronic device is not turned on for the first time, then in this case, the target user may start the historical application set based on the preferences or habits when using the electronic device. Then, these historical application sets can be determined as preset application sets, and display layout information can be set for the preset application sets based on the configuration information of the electronic device.

In some embodiments, in the process at 102, when the target application set matching the target trigger event is activated in response to the target trigger event, the process may include, in response to the electronic device switching from a first usage mode to a second usage mode, outputting at least one application set matching the second usage mode in the first display area, or outputting at least one application set matching the second usage mode and the current device form in the first display area. Then, in response to a target operation acting on the first display area, respectively running at least two applications in the target application set determined by the target operation in at least two display areas.

In some embodiments, switching from the first usage mode to the second usage mode may be: the electronic device switches from a single-use mode to a mode in which the electronic device is connected to other devices for use, or the electronic device switches from a single-use mode to a mode in which the electronic device is connected to the Internet for use, etc.

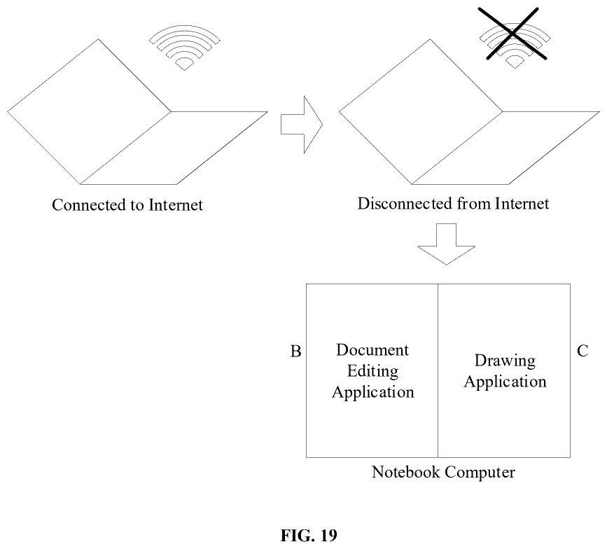

For example, if the notebook computer is switched from an Internet-connected mode to a standalone mode, then the applications on the laptop that require an Internet connection to use will no longer function properly, such as the browser not being able to function properly. Based on this, the notebook computer can output a set of applications that can be used normally when used alone in the first display area. Then, as shown in FIG. 19, in response to the selection operation for the application set, the document editing application and the drawing application in the application set pointed to by the selection operation are respectively run on side B and side C of the notebook computer, and the browser application that was once running on the side B of the notebook computer is no longer activated.

In another example, if the notebook computer is switched from a standalone mode to connected electronic device mode, the applications on the notebook computer that can realize mirroring, screen projection, and file transfer functions can be used normally, such as file transfer applications. Based on this, the notebook computer can output a set of applications that can be used normally when connected to other devices in the first display area. Then, in response to a selection operation on the application set, at least two applications in the application set pointed to by the selection operation can be respectively run in at least two display areas determined based on the display layout information in the application set.

In some embodiments, the current device form may represent the relative form of multiple display modules. For example, the angle between side B and side C of the notebook computer, or the placement direction of the side B and side C of the notebook computer (such as horizontal or vertical placement), etc. Based on this, in this embodiment, the application set to be output in the first display area can be determined in combination with the second usage mode and the current device form.

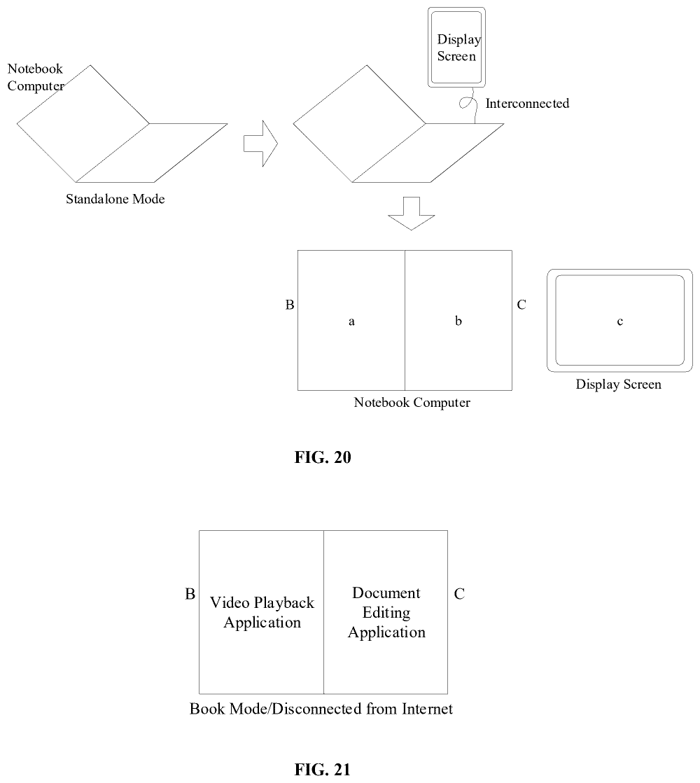

For example, if a notebook computer is switched from standalone mode to a mode where an electronic device is connected to other devices, the file transfer application on the notebook computer can be used normally. In addition, if the angle between the side B and side C of the notebook computer is 180 degrees, that is, the book mode, in this case, the notebook computer can display a set of applications that can be used normally when connected to other devices in the first display area, and the display layout information in the application set can be determined based on the book mode and other display screens connected to the notebook computer. Then, in response to a selection operation for the application set, as shown in FIG. 20, applications a, b, and c in the application set pointed to by the selection operation are respectively run on side B and side C of the notebook computer and the interconnected display screen.

In some embodiments, in the process at 102, when the target application set matching the target trigger event is activated in response to the target trigger event, the process may include, in response to the electronic device switching from a first device form to a second device form, outputting at least one application set matching the second device form in the first display area. Then, in response to a target operation acting on the first display area, respectively running at least two applications in the target application set determined by the target operation in at least two display areas.

For example, the switching from the first device form to the second device form may be a change on the relative positions between different display modules, for example, when the opening and closing angles or placement directions between different display modules change.

For example, when the opening and closing angle between side B and side C of the notebook computer changes or the placement position of the notebook computer changes, the notebook switches from the laptop mode to the book mode or from the book mode to the laptop mode. Based on this, the notebook computer can determine at least one application set based on the switched second device form such as book mode or laptop mode, output these application sets to the first display area, and provide these application sets to the target user for selection. For example, in the set list, all application sets with the usage state attribute of book mode can be displayed and filtered out, and then the application sets ranked in the top N in terms of usage times can be output to the first display area on side B of the notebook computer, where N is a positive integer greater than or equal to 1. The target user can select one of the application sets as the target application set in the first display area, such as a video conferencing application and a document editing application. Based on this, side B of the notebook computer is running the video conferencing application, and side C of the notebook computer is running the document editing application, that is, recording the meeting content in the online meeting. Of course, if the notebook computer is in a usage mode where it cannot connect to the Internet, the video conferencing application cannot be used normally. At this time, the notebook computer can filter out all application sets whose usage state attribute is the book mode and does not rely on the Internet in the set list, and then output the application sets ranked by the top N usage times in these application sets to the first display area on side B of the notebook computer. The target user can select one of the application sets as the target application set in the first display area, such as a video playback application and a document editing application. Based on this, as shown in FIG. 21, the video playback application is run on side B of the notebook computer, and the document editing application is run on side C of the notebook computer, that is, the meeting content is recorded in the locally stored meeting screen recording.

In some embodiments, in the process at 102, when the target application set matching the target trigger event is activated in response to the target trigger event, the process may include, in response to an application program loaded on the electronic device being updated, updating at least one application set outputted in the first display area. Then, in response to a target operation acting on the first display area, respectively running at least two applications in the target application set determined by the target operation in at least two display areas.

In some embodiments, application updates may include installing new applications, uninstalling existing applications, upgrading existing applications, etc.

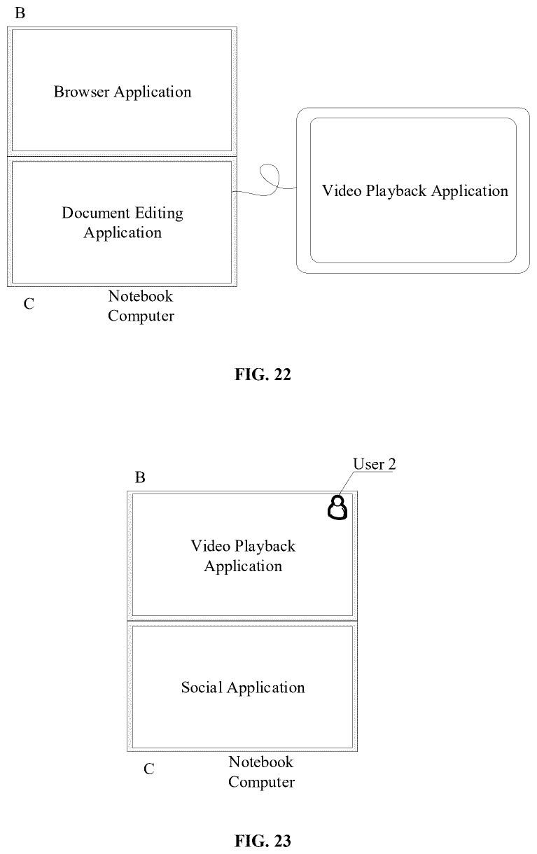

For example, if a video conferencing application is uninstalled from a notebook computer, the notebook computer will need to change the application set even if it is in the Internet-connected usage mode. For example, in response to the video conferencing application being uninstalled, the notebook computer can filter out the application set that does not include the video conferencing application in the set list. Then, based on other factors such as the book mode, other interconnected display screens, workdays, office areas, etc., the application sets that match the current usage mode, current usage form, and current usage environment can be filtered out, and these application sets can be output in the first display area. The target user can select one of the application sets in the first display area as the target application set, such as a video playback application, a document editing application, and a browser application. Based on this, as shown in FIG. 22, the video playback application is running on the connected display of the notebook computer, the browser application is running on side B of the notebook computer, and the document editing application is running on side C of the notebook computer. That is, the meeting content is recorded in the locally stored meeting screen recording, and the browser application is used to search for proper nouns in the meeting.

In some embodiments, in the process at 102, when the target application set matching the target trigger event is activated in response to the target trigger event, the process may include, in response to the user of the electronic device switching from the first user to the second user, outputting at least one application set matching the second user in the first display area. Then, in response to a target operation acting on the first display area, respectively running at least two applications in the target application set determined by the target operation in at least two display areas.

In some embodiments, the switching of the first user to the second user can be understood as the switching of the logged-in user of the electronic device. The application set matching the second user can be understood as the application set matched based on the user profile data of the second user, such as habits, preferences, or historical data.

For example, after user 1 logs out of the notebook computer, then logs in as user 2 to use the notebook computer. Then in response to user 2 logging in, the notebook computer can select the corresponding application set in the set list based on user 2's historical application usage. Then, based on other factors such as the laptop mode, holidays, home, etc., the application sets that match the current usage mode, current usage form, and current usage environment can be filtered out, and these application sets can be output in the first display area. The target user can select one of the application sets as the target application set in the first display area, such as a video playback application and a social application. Based on this, as shown in FIG. 23, the video playback application is run on side B of the notebook computer, and the social application is run on side C of the notebook computer. That is, while watching a video, the social application is used to chat with friends.

In some embodiments, in the process at 102, when the target application set matching the target trigger event is activated in response to the target trigger event, the process may include, in response to the electronic device moving from a first usage environment to a second usage environment, outputting at least one application set matching the second usage environment or matching the second usage environment and the current usage time period in the first display area. Then, in response to a target operation acting on the first display area, respectively running at least two applications in the target application set determined by the target operation in at least two display areas.

In some embodiments, moving from the first usage environment to the second usage environment may include a change in usage time or a change in usage location. For example, an electronic device is moved from the office to home for use or an electronic device is moved from home to office for use. In another example, the electronic device is switched from weekday use to weekend use or the electronic device is switched from weekend use to weekday use. The at least one application set matching the second usage environment may refer to selecting the application set whose usage environment is the second usage environment in the set list. The at least one application set matching the second usage environment and the current usage time period may refer to selecting the application set from the set list whose usage environment is the second usage environment and whose usage time is short and matches the current usage time period.

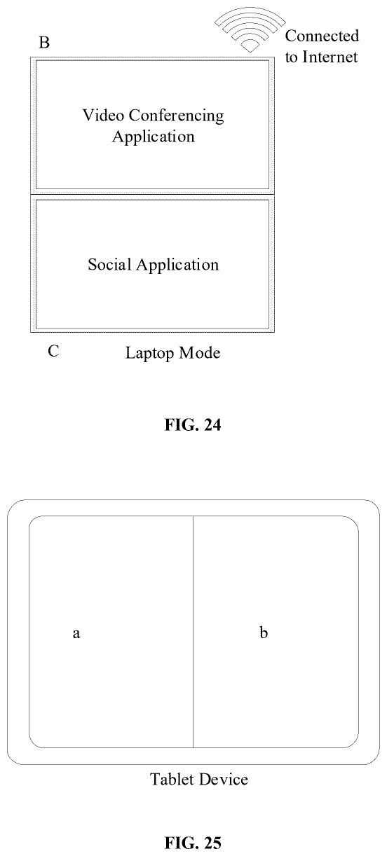

For example, a user brings a notebook computer home from the office, and after turning on the notebook computer, the first display area of the laptop outputs at least a set of applications that match the home environment. Of course, the application set can also match the current usage time period, such as workdays, and can also match the laptop mode, networking, and other factors. Based on this, the target user can select one of the application sets as the target application set in the first display area, such as the video conferencing application and the social application. Based on this, as shown in FIG. 24, the video conferencing application is run on side B of the notebook computer, and the social application is run on side C of the notebook computer. That is, while participating in an online meeting, the social application is used to communicate the meeting details at the same time.

In some embodiments, in the process at 102, when the target application set matching the target trigger event is activated in response to the target trigger event, the process may include, in response to the electronic device entering a second usage time period from a first usage time period, outputting at least one application set matching the second usage time period or matching the second time period and the current usage environment in the first display area. Then, in response to a target operation acting on the first display area, respectively running at least two applications in the target application set determined by the target operation in at least two display areas.

In some embodiments, entering the second usage time period from the first usage time period may be that the usage time period of the electronic device has changed.

For example, from the working day to the weekend, after the notebook computer is turned on, the first display area of the laptop can output at least a set of applications that match the weekend time period. Of course, the application set can also match the current usage environment, such as the office area, and can also match the laptop mode and other factors. Based on this, the target user can select one of the application sets as the target application set in the first display area, such as the video conferencing application and the social application. Based on this, a video conferencing application can run on side B of the notebook computer, and a social application can run on side C of the notebook computer. That is, while working overtime on the weekend to participate in an online meeting, the user can use the social application to communicate meeting details with colleagues.

In some embodiments, in the process at 102, when the target application set matching the target trigger event is activated in response to the target trigger event, the process may include running two applications in the first application set determined by the target user in a third display area and a fourth display area of the electronic device based on the display layout information in the first application set.

In some embodiments, the third display area and the fourth display area may belong to the same display module or different display modules of the electronic device. The electronic device may be a single-screen device or a multi-screen device, and the electronic device may also be connected to an independent display screen. The third display area and the fourth display area may be located in the same display module of a single-screen device; or, the third display area and the fourth display area may be located in different display modules of a multi-screen device, respectively.

It should be noted that the first application set determined by the target user may be an application set determined by the target user through a target operation such as a selection operation or a custom configuration operation.

For example, as shown in FIG. 25, both application a and application b are displayed in the first application set determined by the target user on the display screen of the tablet device. Application a in the third display area of the tablet device, and application b in the fourth display area of the tablet device.

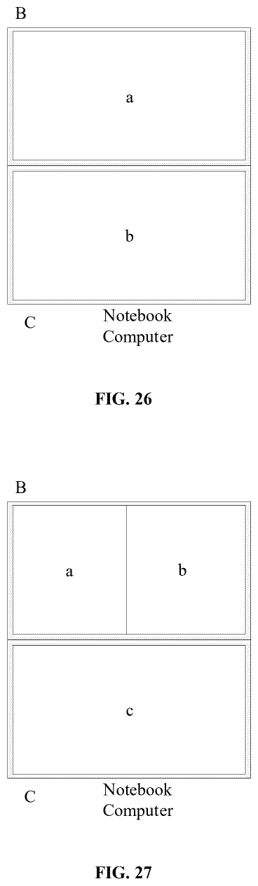

In another example, as shown in FIG. 26, application a and application b in the first application set determined by the target user are displayed on side B and side C of the notebook computer, respectively.

In some embodiments, in the process at 102, when the target application set matching the target trigger event is activated in response to the target trigger event, the process may include respectively displaying and running the three applications in the second application set determined by the target user and run in the third display area, the fourth display area and the fifth display area of the electronic device based on the display layout information in the second application set.

In some embodiments, the third display area and the fourth display area may belong to the first display module of the electronic device, and the fifth display area may belong to the second display module of the electronic device. For example, the third display area and the fourth display area both belong to side B of the notebook computer, and the fifth display area belongs to side C of the notebook computer; or, the third display area and the fourth display area both belong to side C of the notebook computer, and the fifth display area belongs to side B of the notebook computer.

It should be noted that the second application set determined by the target user may be an application set determined by the target user through a target operation such as a selection operation or a custom configuration operation.

For example, as shown in FIG. 27, application a and application b in the second application set determined by the target user are respectively displayed on the display screen of side B of the notebook computer, and application c in the second application set is displayed on the display screen of side C of the notebook computer.

In some embodiments, in the process at 102, when the target application set matching the target trigger event is activated in response to the target trigger event, the process may include displaying two applications in the fifth application set that match the target trigger event in the sixth display area and the seventh display area of the electronic device based on the display layout information in the fifth application set, the sixth display area belonging to the first display module of the electronic device, and the seventh display area belonging to the second display module of the electronic device. For example, the first display module and the second display module may be two display screens of a dual-screen device (such as a dual-screen notebook computer); or, one of the first display module and the second display module may be a display screen in an external device of the electronic device. For example, the sixth display area may belong to side B of the dual-screen notebook computer, and the seventh display area may belong to side C of the notebook computer; or the sixth display area may belong to side B of the notebook computer, and the seventh display area may belong to the external display screen of the notebook computer.

In some embodiments, the first display module and the second display module may be two display screens in a multi-screen device; or, one of the first display module and the second display module may be an external display screen connected to a single-screen device. The fifth application set may be an application set determined in response to first feedback information for the first prompt after the first prompt is output in the second display area.

For example, as shown in FIG. 26, application a in the fifth application set matching the target trigger event is displayed on the display screen on side B of the notebook computer, and application b in the fifth application set is displayed on side C of the notebook computer.

In some embodiments, the control method may include obtaining the usage state change information of the display module of the electronic device, and updating at least one application set output in the first display area and/or updating the display parameters of the at least two applications based on the usage state change information.

In some embodiments, the usage state change information of the display module may include the screen-on and screen-off state information of the display module, the opening and closing angle information of the display module, the usage direction information of the display module (forward direction or reverse direction), etc.

In some embodiments, updating the application set output in the first display area may include adding, deleting, replacing applications in the application set, and adjusting the display layout information in the application set. Updating the display parameters of the application may include updating the display position, display direction, display window size and other parameters of the application window.

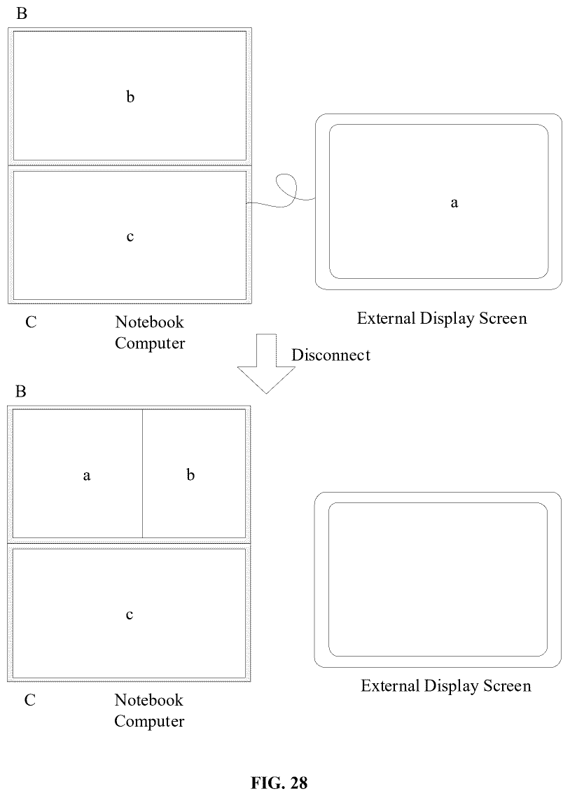

For example, if the notebook computer switches from being connected to an external display screen to being disconnected from the external display screen, then based on the two display screens on side B and side C of the existing notebook computer, the application set in the first display area can be replaced to prompt the target user to select or customize the configuration, or the display layout information of the applications included in the application set in the first display area can be adjusted. As shown in FIG. 28, when the notebook computer is connected to an external display, the first display area outputs an application set including applications a, b, and c. Application a runs on the external display, application b runs on side B of the notebook computer, and application c runs on side C of the notebook computer. After the external display screen of the notebook computer is disconnected, the first display area outputs an application set including applications a, b, and c. Application a and application b run on side B of the notebook computer, and application c runs on side C of the notebook computer.

Consistent with the present disclosure, the application set or the display parameters in the application set in the first display area can be adjusted based on the change of the usage state of the display module such that the change of the display module can be adaptively adjusted to improve the user's experience of using the electronic device.

In some embodiments, the control method may include, in response to obtaining the operating state change information of at least one application currently displayed and running, updating the display parameters of other applications in the target application set.

In some embodiments, the operating state change information may be information such as the application being closed, the application window being minimized, the application window being enlarged or reduced, and the position of the application window being adjusted.

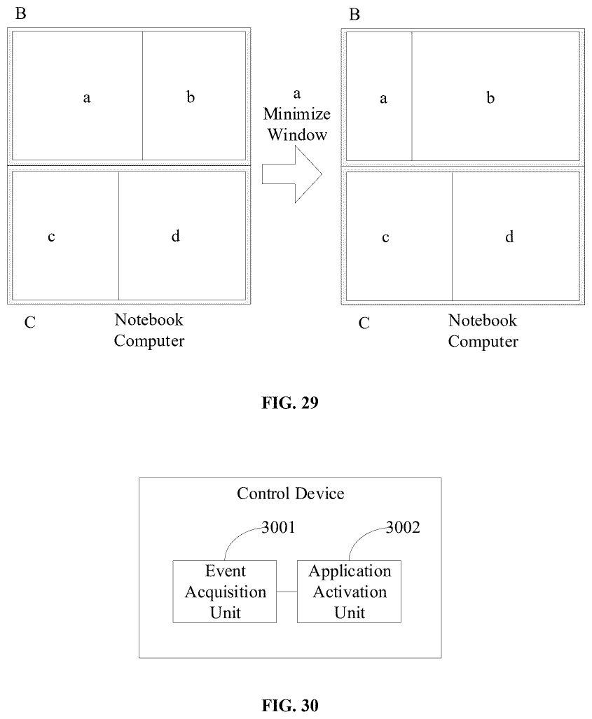

For example, as shown in FIG. 29, if four applications a, b, c, and d are running on side B and side C of the notebook computer respectively, if the window of application a is reduced, then the window size of application b on the same display module as application a should be adjusted accordingly.

Consistent with the present disclosure, the display parameters of the applications in the target application set can be adjusted based on the operating state change information of the currently running application to adapt to the changes in the operating state of the application and improve the user experience of the electronic device.

In some embodiments, the control method may include obtaining target output data of at least one application in the target application set such that when at least two applications in the target application set are respectively running in at least two display areas, the target output data can be output in at least one of the display areas.

In some embodiments, the target output data may include historical output data of at least one application or determined to-be-output data.

More specifically, the historical output data of an application may be read from the cache. For example, the historical output data of an application may be cached to the corresponding application area when the application is closed. For example, when a document editing application is closed, the document being edited can be saved in the cache; in another example, when an image drawing application is closed, the image being drawn can be saved in the cache.

Alternatively, the application's output data may be obtained based on the application's corresponding startup instruction. The startup instruction can be understood as a trigger application startup instruction. For example, when a user needs to open a document, he clicks the document logo, and the generated startup instruction is used to trigger the start of the document editing application such that the document editing application can output the document content of the document. In another example, when the user needs to watch a video, he clicks on the video logo, and the generated start instruction is used to trigger the start of the video playback application such that the video playback application can output the video.

For example, the target output data of application a is the historical output data being output when application a was last closed. Take a document editing application as an example, its target output data may be a word document or a ppt document that was last edited by the document editing application; take a browser application as an example, its target output data may be the webpage that was last opened by the browser application; take a video playback application as an example, its target output data may be the video content that was last watched by the video playback application; take a social application as an example, its target output data may be the conversation window that was recently opened by the social application, etc.

Alternatively, the target output data of application a may be the default output data or the to-be-output data after application a is started. Take a document editing application as an example, its target output data may be a newly created blank document in the document editing application or a document pointed to by a startup instruction (i.e., a document that the document editing application needs to open when the user clicks on the document identifier); take a browser application as an example, its target output data may be a default web page of the browser application; take a video playback application as an example, its target output data may be the video content pointed to by the startup instruction (i.e., video playback instruction) received by the video playback application; take an image drawing application as an example, its target output data may be the image pointed to by the startup instruction (i.e., image drawing instruction) received by the image drawing application.

In some embodiments, the application set in the set list may be obtained by, in response to an operating instruction for an application window, determining whether multiple application windows displayed in a display area meet a combination condition; in response to multiple application windows meeting the combination condition, generating a corresponding application set based on the application identifier corresponding to each application corresponding to the multiple application windows; adding the application set to the set list.

In some embodiments, the operating instruction may include an instruction to select an application window; an instruction to open an application window; an instruction to adjust the window size of an application window; an instruction to adjust the window position of an application window, etc. The combination condition may include multiple application windows filling the display area.

In some embodiments, the display areas may belong to the same display module or different display modules. For example, two application windows on side B of the notebook computer cover the entire side B, and one application window on side C of the notebook computer covers the entire side C. At this time, the two applications on side B and the one application on the side C can be combined into an application set, and the application set includes the display layout information between the two applications on side B and the one application on side C. The application set may also correspond to a usage count, which represents the historical number of times the application set has been used.

In some embodiments, the target application set that matches the target trigger event may be obtained by filtering based on the corresponding filtering parameters in the set list.

In some embodiments, the filtering parameters may include a usage time period parameter, a usage location parameter, a usage mode, and a usage frequency. For example, the usage time period parameter may be used to indicate whether the current time is a working day or a holiday, the location parameter may be used to indicate whether the current location is an office or a home, and the usage mode parameter may be used to indicate whether the electronic device is in a laptop mode or a book mode.

Consistent with the present disclosure, based on the usage time period parameter, usage location parameter, and usage mode, the top N application sets can be filtered out by usage frequency, and these N application sets can be output in the first display area and provided to the target user for target operation. If the N application sets cannot be filtered out based on the usage time period parameter, usage location parameter, and usage mode, then the filtering parameters can be adjusted, and only the top N application sets can be filtered out based on the usage location parameter and usage mode, and these N application sets can be output in the first display area and provided to the target user for target operation. If the N application sets are still not filtered out, the filtering parameters can be adjusted again, the first N application sets can be filtered out only based on the usage mode parameters, these N application sets can be output in the first display area and provided to the target user for target operation. If the N application sets are still not filtered out, then only N application sets can be filtered out based on the number of times used; if the total number of application sets in the set list is less than N, then all application sets can be output in the first display area and provided to the target user for target operation.

FIG. 30 is a schematic structural diagram of a control device according to some embodiments of the present disclosure. The control device can be arranged on an electronic device loaded with applications. As shown in FIG. 30, the control device includes an event acquisition unit 3001 and an application activation unit 3002.

In some embodiments, the event acquisition unit 3001 may be configured to obtain a target trigger event.

In some embodiments, the application activation unit 3002 may be configured to activate the target application set matching the target trigger event in response to the target trigger event, and run at least two applications in the target application set in the determined target display area respectively.

In some embodiments, the target application set may also include display layout information of the application, and the target display area may include at least one display area determined based on the display layout information.

Consistent with the present disclosure, the control device can activate a target application set matching the target trigger event in response to the target trigger event, and run at least two applications in the target application set in the determined target display area respectively. The target application set can also include display layout information of the application, and at least one display area in the target display area where the application runs can be determined based on the display layout information in the target application set. Accordingly, based on the display layout information, the applications in the application set can be run in the corresponding display areas. There is no need for the user to manually activate each application or manually adjust the display area where each application runs, thereby reducing the user's operation complexity and improving the user experience.

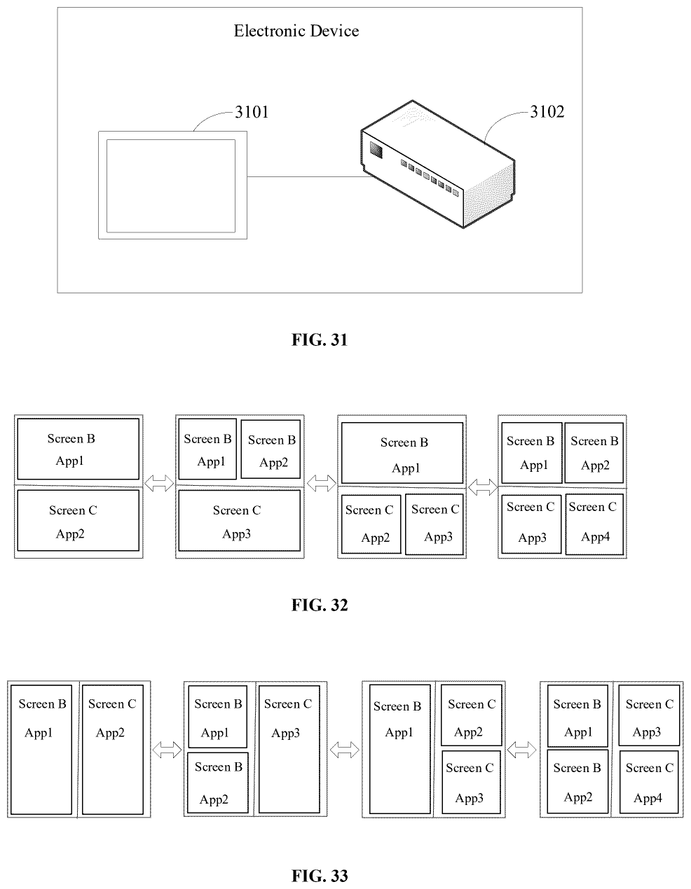

FIG. 31 is a schematic structural diagram of an electronic device according to some embodiments of the present disclosure. As shown in FIG. 31, the electronic device includes a display 3101 and a processor 3102.

In some embodiments, the display 3101 may be used to provide a target display area.

In some embodiments, the processor 3102 may be configured to obtain a target trigger event; in response to the target trigger event, activate a target application set that matches the target trigger event, and run at least two applications in the target application set in the determined target display area respectively.

Consistent with the present disclosure, the electronic device can activate a target application set matching the target trigger event in response to the target trigger event, and run at least two applications in the target application set in the determined target display area respectively. The target application set can also include display layout information of the application, and at least one display area in the target display area where the application runs can be determined based on the display layout information in the target application set. Accordingly, based on the display layout information, the applications in the application set can be run in the corresponding display areas. There is no need for the user to manually activate each application or manually adjust the display area where each application runs, thereby reducing the user's operation complexity and improving the user experience.

The technical solution of the present disclosure is explained below by taking a dual-screen notebook computer as an example.

In many cases, users need to open multiple applications (apps) on their notebook computers to work, for example, opening a browser to search for information and opening Word or PPT for editing at the same time. Especially on dual-screen notebook computers (including screen B and screen C, i.e., side B and side C described above), more applications can be opened at the same time. There are big differences in the number of applications a user uses on weekdays and non-workdays, and there are also big differences in the number of applications a user uses at home or at work. It is cumbersome for a user to open a group of applications, and the user needs to start the applications one by one and move them to the appropriate location. There are also times when users are not aware of which applications are frequently used at the same time, and the computer needs to identify these applications intelligently.

In view of this, the technical solutions provided in the embodiments of the present disclosure can automatically identify the application combination with high frequency of user usage (i.e., the application set mentioned above) based on the difference between working days and non-working days and locations, and recommends the application combination to the user based on whether it is a working day and the location, and provides a one-click launch function for the application combination. In addition, when the user is using the application, the file currently being opened by the reading or editing application can be identified. Based on this, when the user starts an application in the application combination, the most recently used document can also be opened at the same time.

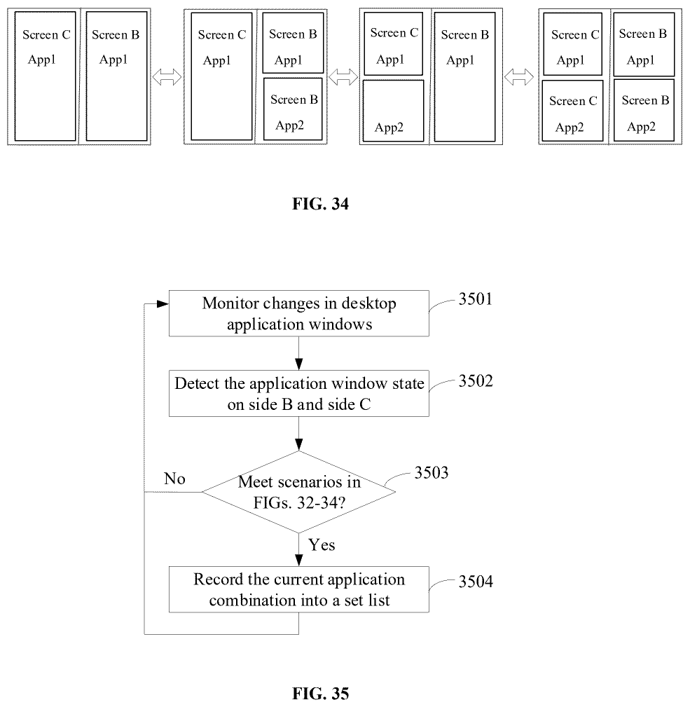

FIG. 32 is an example of some possible application combinations on the dual-screen notebook computer in a landscape mode according to some embodiments of the present disclosure. FIG. 33 is an example of some possible application combinations on the dual-screen notebook computer in a portrait mode with screen B on the left according to some embodiments of the present disclosure. FIG. 34 is an example of some possible application combinations on the dual-screen notebook computer in the portrait mode with screen B on the right according to some embodiments of the present disclosure.

FIG. 35 is a flowchart of identifying a combination of applications used frequently in a notebook computer according to some embodiments of the present disclosure. The method will be described in detail below.
3501, monitoring changes in desktop application windows, such as opening windows, window hierarchy changes, window size changes, and window position changes.
3502, detecting the application window state on side B and side C.
3503, determining whether the application window state meets any of the scenarios described in FIG. 32, FIG. 33 and FIG. 34. If so, perform the process at 3504; otherwise, return to the process at 3501.
3504, recording the current application combination into a set list with usage time duration, usage location, usage mode, display layout information, etc. In addition, if the application has opened a file, identifying and recording the opened file. That is, the target output data of the application described above is recorded. Subsequently, return to the process at 3501.

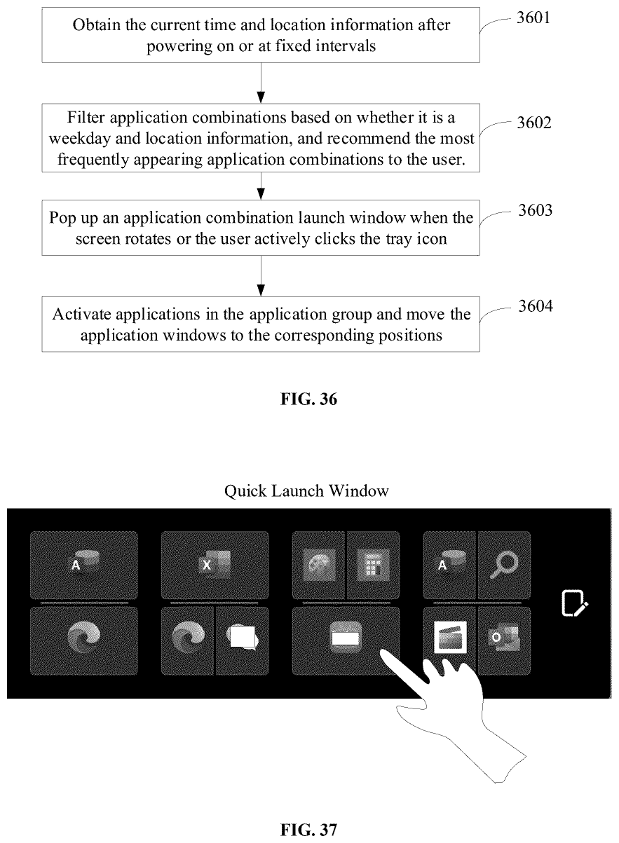

FIG. 36 is a flowchart of recommending and launching application combinations in a notebook computer according to some embodiments of the present disclosure.
3601, obtaining the current time and location information after powering on or at fixed intervals.
3602, filtering application combinations based on whether it is a weekday and location information, and recommending the most frequently appearing application combinations to the user.
3603, popping up an application combination launch window when the screen rotates or the user actively clicks the tray icon, such as the quick launch window of the application combination shown in FIG. 37, that is, the first display area.
3604, activating applications in the application group and moving the application windows to the corresponding positions.

It should be noted that after starting an application in the application combination, if the application has opened a file when it was last used, then the file that was last opened will be opened after the application is started such that the started application will output the file content that was output when it was last closed.

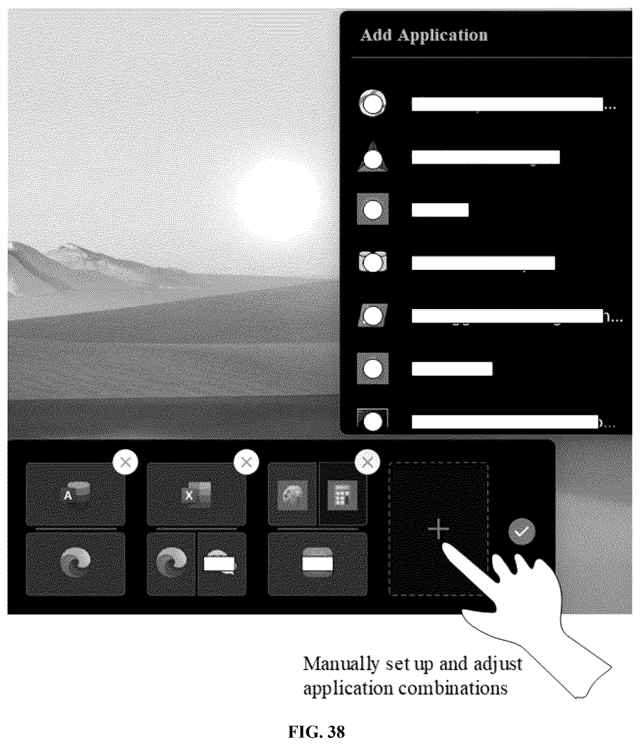

In addition, the user can edit the application combination in the quick launch window such as shown in FIG. 38, which is a schematic diagram of a window applicable to manual setting and adjustment of application combinations by users in a notebook computer according to some embodiments of the present disclosure.

Consistent with the present disclosure, the application combinations that the users use frequently can be identified, and different application combinations can be recommended based on time and location, and a simple interface is used to allow users to start the applications with one click. The present disclosure also provides a method to actively set application combinations, allowing users to combine and adjust application combinations more flexibly. In addition, the technical solutions of the present disclosure also help users record recently used documents. These documents can be opened directly when users start the application combination, thereby further simplifying the user's operation steps and saving time in finding documents.

In the present disclosure, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

As will be appreciated by those of ordinary skill in the art, the embodiments disclosed herein can be implemented by way of electronic hardware, computer software, or a combination of the two. To clearly illustrate the interchangeability between hardware and software, components and steps of respective examples have already been described in a general way in terms of functions in the above description. These functions are to be executed by hardware manner or software depending upon the particular application of the technique process and design constraints. Those skilled in the art can use different methods to achieve the described functions with respect to each specific application, but such implementation should not be construed as going beyond the scope of the present disclosure.

The processes of the methods or algorithms described in conjunction with the embodiments of the present disclosure can be implemented with hardware, software modules executed by a processor, or a combination thereof. The software modules may reside in a random-access memory (RAM), an internal memory, a read-only memory (ROM), an electrically programmable ROM, an electrically-erasable programmable ROM, a register, a hard disk, a removable disk drive, CD-ROM, or other types of storage media well known in the technical field.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. A control method comprising:
in response to a target trigger event, activating a target application set matching the target trigger event, and respectively running at least two applications in the target application set in a determined target display area, wherein:
the target application set includes display layout information of the application, and the target display area includes at least one display area determined based on the display layout information.

2. The method of claim 1, wherein activating the target application set matching the target trigger event, and respectively running at least two applications in the target application set in the determined target display area includes:
in response to the target trigger event, outputting at least one application set matching the target trigger event in a first display area of an electronic device, the application set including the display layout information of the included applications; and
in response to a target operation acting on the first display area, respectively running at least two applications in the target application set determined by the target operation in at least two display areas, the at least two display areas being determined based on the display layout information included in the target application set, the at least two display areas belonging to a same display module or different display modules.

3. The method of claim 2, wherein, in response to the target operation acting on the first display area, respectively running at least two applications in the target application set determined by the target operation in at least two display areas includes one of more of:
in response to a selection operation acting on the first display area, respectively running at least two applications in a first application set pointed to by the selection operation in the at least two display areas determined based on the display layout information in the first application set;
in response to a custom configuration operation acting on the first display area, respectively running at least two applications in a second application set that is custom configured by a target user in the at least two display areas determined based on the display layout information in the second application set;
in response to a sorting operation acting on the first display area, respectively running at least two applications in a third application set in a target sequence in the at least two display areas determined based on the display layout information in the third application set; or
in response to obtaining first input data representing a target intent, respectively running at least two applications in a fourth application set matching the target intent in the at least two display areas determined based on the display layout information in the fourth application set.

4. The method of claim 1, wherein activating the target application set matching the target trigger event, and respectively running at least two applications in the target application set in the determined target display area includes:
in response to the target trigger event, outputting a first prompt of a fifth application set matching the target trigger event in a second display area of the electronic device; and
in response to obtaining first feedback information for the first prompt, respectively running at least two applications in the fifth application set in the at least two display areas determined based on the display layout information in the fifth application set, the at least two display areas belonging to the same display module or different display modules.

5. The method of claim 4 further comprising one of more of:
in response to obtaining second feedback information for the first prompt, outputting a second prompt of a sixth application set matching the target trigger event in the second display area or a third display area of the electronic device, at least one application and/or display layout information in the sixth application set being different from that in the fifth application set;
in response to obtaining third feedback information for the first prompt or for the second prompt, outputting a third prompt for custom configuration of the target application set in the first display area of the electronic device to prompt the target user to configure the needed target application set; or
in response to obtaining fourth feedback information for the first prompt or for the second prompt, outputting a fourth prompt for an editing operation on the fifth application set or the sixth application set to prompt the target user to perform the editing operation on the fifth application set or the sixth application set.

6. The method of claim 1, wherein, in response to the target trigger event, activating the target application set matching the target trigger event includes one or more of:
if the target trigger event is unrelated to a usage state of the electronic device, activating the target application set matching the target trigger event based on a preset association relationship between the target trigger event and the target application set;
if the target trigger event is related to the usage state of the electronic device, activating the corresponding target application set based on change information of the usage state; or
if the target trigger event is related to the usage state of the electronic device, activating the corresponding target application set based on the change information of the usage state and external reference factors.

7. The method of claim 1, wherein, in response to the target trigger event, activating the target application set matching the target trigger event includes one or more of:
in response to the electronic device switching from a first power state to a second power state, outputting a preset application set in the first display area, the preset application set being created based on big data or user profile data of the target user and/or configuration information of the electronic device;
in response to the electronic device switching from a first usage mode to a second usage mode, outputting at least one application set matching the second usage mode in the first display area, or outputting at least one application set matching the second usage mode and a current device form in the first display area;
in response to the electronic device switching from a first device form to a second device form, outputting at least one application set matching the second device form in the first display area;
in response to an application program loaded on the electronic device being updated, updating at least one application set output in the first display area;
in response to a user of the electronic device switching from a first user to a second user, outputting at least one application set matching the second user in a first display area;
in response to the electronic device being moved from a first usage environment to a second usage environment, outputting at least one application set matching the second usage environment or matching the second usage environment and a current usage time period in the first display area; or
in response to the electronic device entering a second usage time period from a first usage time period, outputting at least one application set matching the second usage time period or matching the second time period and a current usage environment in the first display area.

8. The method of claim 1, wherein respectively running at least two applications in the target application set in the determined target display area includes one or more of:
respectively running two applications in the first application set determined by the target user in the third display area and a fourth display area of the electronic device based on the display layout information in the first application set, the third display area and the fourth display area belonging to the same display module or different display modules of the electronic device;
displaying three applications in the second application set determined by the target user based on the display layout information in the second application set, and respectively running the three applications in the third display area, the fourth display area, and a fifth display area of the electronic device, the third display area and the fourth display area belonging to a first display module of the electronic device, the fifth display area belonging to a second display module of the electronic device; or
displaying two applications in the fifth application set matching the target trigger event in a sixth display area and a seventh display area of the electronic device based on the display layout information in the fifth application set, the sixth display area belonging to the first display module of the electronic device, the seventh display area belonging to the second display module of the electronic device.

9. The method of claim 2 further comprising one or more of:
obtaining usage state change information of the display module of the electronic device, and updating at least one application set outputted by the first display area and/or updating display parameters of at least two applications based on the usage state change information;
in response to obtaining an operating state change information of at least one application currently displayed and running, updating the display parameters of other applications in the target application set; or
obtaining target output data of at least one application in the target application set, when the at least two applications in the target application set are respectively running in at least two display areas, the target output data being output in at least one of the display areas, wherein:
the target output data includes historical output data of the at least one application or determined to-be-output data.

10. A notebook computer comprising:
two or more display screens, the two or more display screens being rotatably connected to each other; and
a processor, the processor being configured to obtain a target trigger event; activate a target application set matching the target trigger event in response to the target trigger event, and to respectively run at least two applications in the target application set in a determined target display area of the two or more display screens, wherein:
the target application set includes display layout information of the application, and
the target display area includes at least one display area determined based on the display layout information.

11. An electronic device comprising:
a display, the display being used to provide a target display area; and
a processor, the processor being configured to obtain a target trigger event; activate a target application set matching the target trigger event in response to the target trigger event, and to respectively run at least two applications in the target application set in a determined target display area, wherein:
the target application set includes display layout information of the application, and the target display area includes at least one display area determined based on the display layout information.

12. The electronic device of claim 11, wherein the processor is configured to:
in response to the target trigger event, output at least one application set matching the target trigger event in a first display area of an electronic device, the application set including the display layout information of the included applications; and
in response to a target operation acting on the first display area, respectively run at least two applications in the target application set determined by the target operation in at least two display areas, the at least two display areas being determined based on the display layout information included in the target application set, the at least two display areas belonging to a same display module or different display modules.

13. The electronic device of claim 12, wherein the processor is configured to:
in response to a selection operation acting on the first display area, respectively run at least two applications in a first application set pointed to by the selection operation in the at least two display areas determined based on the display layout information in the first application set;
in response to a custom configuration operation acting on the first display area, respectively run at least two applications in a second application set that is custom configured by a target user in the at least two display areas determined based on the display layout information in the second application set;
in response to a sorting operation acting on the first display area, respectively run at least two applications in a third application set in a target sequence in the at least two display areas determined based on the display layout information in the third application set; or
in response to obtaining first input data representing a target intent, respectively run at least two applications in a fourth application set matching the target intent in the at least two display areas determined based on the display layout information in the fourth application set.

14. The electronic device of claim 11, wherein the processor is configured to:
in response to the target trigger event, output a first prompt of a fifth application set matching the target trigger event in a second display area of the electronic device; and
in response to obtaining first feedback information for the first prompt, respectively run at least two applications in the fifth application set in the at least two display areas determined based on the display layout information in the fifth application set, the at least two display areas belonging to the same display module or different display modules.

15. The electronic device of claim 14, wherein the processor is configured to:
in response to obtaining second feedback information for the first prompt, output a second prompt of a sixth application set matching the target trigger event in the second display area or a third display area of the electronic device, at least one application and/or display layout information in the sixth application set being different from that in the fifth application set;
in response to obtaining third feedback information for the first prompt or for the second prompt, output a third prompt for custom configuration of the target application set in the first display area of the electronic device to prompt the target user to configure the needed target application set; or
in response to obtaining fourth feedback information for the first prompt or for the second prompt, output a fourth prompt for an editing operation on the fifth application set or the sixth application set to prompt the target user to perform the editing operation on the fifth application set or the sixth application set.

16. The electronic device of claim 11, wherein the processor is configured to:
if the target trigger event is unrelated to a usage state of the electronic device, activate the target application set matching the target trigger event based on a preset association relationship between the target trigger event and the target application set;
if the target trigger event is related to the usage state of the electronic device, activate the corresponding target application set based on change information of the usage state; or
if the target trigger event is related to the usage state of the electronic device, activate the corresponding target application set based on the change information of the usage state and external reference factors.

17. The electronic device of claim 11, wherein the processor is configured to:
in response to the electronic device switching from a first power state to a second power state, output a preset application set in the first display area, the preset application set being created based on big data or user profile data of the target user and/or configuration information of the electronic device;
in response to the electronic device switching from a first usage mode to a second usage mode, output at least one application set matching the second usage mode in the first display area, or output at least one application set matching the second usage mode and a current device form in the first display area;
in response to the electronic device switching from a first device form to a second device form, output at least one application set matching the second device form in the first display area;
in response to an application program loaded on the electronic device being updated, update at least one application set output in the first display area;
in response to a user of the electronic device switching from a first user to a second user, output at least one application set matching the second user in a first display area;
in response to the electronic device being moved from a first usage environment to a second usage environment, output at least one application set matching the second usage environment or matching the second usage environment and a current usage time period in the first display area; or
in response to the electronic device entering a second usage time period from a first usage time period, output at least one application set matching the second usage time period or matching the second time period and a current usage environment in the first display area.

18. The electronic device of claim 11, wherein the processor is configured to:
respectively run two applications in the first application set determined by the target user in the third display area and a fourth display area of the electronic device based on the display layout information in the first application set, the third display area and the fourth display area belonging to the same display module or different display modules of the electronic device;
display three applications in the second application set determined by the target user based on the display layout information in the second application set, and respectively run the three applications in the third display area, the fourth display area, and a fifth display area of the electronic device, the third display area and the fourth display area belonging to a first display module of the electronic device, the fifth display area belonging to a second display module of the electronic device; or
display two applications in the fifth application set matching the target trigger event in a sixth display area and a seventh display area of the electronic device based on the display layout information in the fifth application set, the sixth display area belonging to the first display module of the electronic device, the seventh display area belonging to the second display module of the electronic device.

19. The electronic device of claim 12, wherein the processor is configured to:
obtain usage state change information of the display module of the electronic device, and update at least one application set outputted by the first display area and/or update display parameters of at least two applications based on the usage state change information;
in response to obtaining an operating state change information of at least one application currently displayed and running, update the display parameters of other applications in the target application set; or
obtain target output data of at least one application in the target application set, when the at least two applications in the target application set are respectively running in at least two display areas, the target output data being output in at least one of the display areas, wherein:
the target output data includes historical output data of the at least one application or determined to-be-output data.

20. The electronic device of claim 10, wherein:
the electronic device is a notebook computer including a first display screen and a second display screen, and adjusting an angle between the first display screen and the second display screen causes the electronic device to switch to different usage modes, the corresponding target application set being configured to display in at least a partial display area of the first display screen and/or the second display screen after the angle between the first display screen and the second display screen is adjusted.
